(19) United States
(12) Patent Application Publication
(10) Pub. No.: US 2023/0123795 A1
(43) Pub. Date: Apr. 20, 2023

(54) SINGULATION OF OPTICAL DEVICES FROM OPTICAL DEVICE SUBSTRATES VIA LASER ABLATION

(71) Applicant: Applied Materials, Inc., Santa Clara, CA (US)

(72) Inventors: Wei-Sheng LEI, San Jose, CA (US); Zhengping YAO, Cupertino, CA (US); Mahendran CHIDAMBARAM, Saratoga, CA (US); Kangkang WANG, San Jose, CA (US); Zhihong John LIN, Sunnyvale, CA (US); Ludovic GODET, Sunnyvale, CA (US); Visweswaren SIVARAMAKRISHNAN, Cupertino, CA (US)

(21) Appl. No.: 17/945,861

(22) Filed: Sep. 15, 2022

Related U.S. Application Data
(60) Provisional application No. 63/256,415, filed on Oct. 15, 2021.

(51) Int. Cl. B23K 26/364; B23K 26/0622

(52) U.S. Cl. CPC B23K 26/364; B23K 26/0624; B23K 2103/50

(57) ABSTRACT

A method and apparatus for dicing optical devices from a substrate are described herein. The method includes the formation of a plurality of trenches using radiation pulses delivered to the substrate. The radiation pulses are delivered in a pattern to form trenches with varying depth as the trenches extend outward from a top surface of the optical device. The varying depth of the trenches provides edges of each of the optical devices which are slanted. The radiation pulses are UV radiation pulses and are delivered in bursts around the silhouette of the optical devices.

### CROSS-REFERENCE TO RELATED APPLICATIONS

This application claims the benefit of U.S. Provisional Patent Application Ser. No. 63/256,415, filed Oct. 15, 2021, which is incorporated by reference herein in its entirety.

### BACKGROUND

### Field

Embodiments of the present disclosure generally relate to optical devices. Specifically, embodiments of the present disclosure relates to a method for dicing one or more optical devices from a substrate with a laser machining system.

### Description of the Related Art

Virtual reality (VR) is generally considered to be a computer generated simulated environment in which a user has an apparent physical presence. A VR experience can be generated in 3D and viewed with a head-mounted display (HMD), such as glasses or other wearable display devices that have near-eye display panels as lenses to display a VR environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhances or augments the environment that the user experiences. In order to achieve an AR experience, a virtual image is overlaid on an ambient environment, with the overlaying performed by optical devices.

Multiple optical devices are fabricated on a substrate and then diced prior to use on VR and AR devices. Conventional methods of dicing optically transparent materials such as glass and silicon carbide (SiC) substrates include laser ablation cutting or filamentation. During the methods for dicing one or more optical devices from a substrate, it is critical to accurately dice the optical devices from the substrate to retain the quality of the optical devices. The optical devices, generally including high bandgap materials, are brittle and sensitive to thermal or mechanical stresses. Further, the draft angle of the sidewall of each optical device has been found to influence the performance of the device. Attempts to form a draft angle using filamentation processes or laser waterjet dicing are difficult.

Accordingly, there is a need for a method for dicing one or more optical devices from a substrate with a laser machining system which enable angled sidewalls.

### SUMMARY

The present disclosure generally relates to methods of dicing optical devices from a substrate. In one embodiment, a method of dicing an optical device from a substrate includes forming a first trench by exposing the substrate to one or more first radiation pulses around a circumference of the optical device, forming a second trench by exposing the substrate to one or more second radiation pulses around the circumference of the optical device, and forming one or more additional trenches by exposing the substrate to one or more additional radiation pulses around the circumference of the optical device. The first trench has a first depth. The second trench has a second depth greater than the first depth. The second trench is concentric about the first trench. Each additional trench of the one or more additional trenches has a depth greater than a previous depth of a previously formed trench. Each subsequently formed additional trench is concentric about a previously formed additional trench.

In another embodiment, a method of dicing one or more optical devices within a substrate is described. The method includes forming a first tapered edge around a first optical device by forming a plurality of trenches around the first optical device using one or more bursts of radiation pulses. The plurality of trenches vary in depth from a top surface of the substrate. A second tapered edge is formed around a second optical device by forming a plurality of trenches around the second optical device using one or more bursts of radiation pulses. The plurality of trenches vary in depth from the top surface of the substrate. The first optical device and the second optical device are removed from the substrate after forming the first tapered edge and the second tapered edge.

In yet another embodiment, a non-transitory computer-readable medium is described. The non-transitory computer-readable medium stores instructions that, when executed by a processor, cause a computer system to perform the steps of: forming a tapered edge around a first optical device. The tapered edge is formed by instructing a laser source to deliver one or more first radiation pulses to a substrate around a circumference of the first optical device to form a first trench. The first trench has a first depth and the substrate is disposed on a stage. One or both of the stage and the laser source are instructed to move during delivery of the first radiation pulses. The laser source is further instructed to deliver one or more second radiation pulses to the substrate around the circumference of the first optical device to form a second trench. The second trench has a second depth greater than the first depth and the second trench is formed radially outward of the first trench. One or both of the stage and the laser source are instructed to move during delivery of the first radiation pulses. The laser source is further instructed to deliver one or more additional radiation pulses to the substrate around the circumference of the first optical device to form one or more additional trenches. Each additional trench of the one or more additional trenches has a depth greater than a previous depth of a previously formed trench. Each subsequently formed additional trench is concentric about a previously formed additional trench. One or both of the stage and the laser source are instructed to move during delivery of the one or more additional radiation pulses.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic top-view of a substrate according to embodiments.

FIG. 2 is a schematic cross-sectional view of a laser machining system according to embodiments.

FIG. 3 is a flow diagram of a method for dicing one or more optical devices from a substrate according to embodiments.

FIGS. 4A-4E are schematic cross-sectional views of an optical device during the method of FIG. 3 according to embodiments.

FIG. 5 is a schematic plan view an optical device from a substrate according to embodiments.

FIGS. 6A and 6B are schematic cross-sectional views of an optical device after dicing according to embodiments.

FIG. 7 is a schematic side view of an optical device of the one or more optical devices after dicing according to embodiments.

FIGS. 8A and 8B are schematic plan views of optical devices after dicing according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. Specifically, embodiments of the present disclosure relates to a method for dicing one or more optical devices from a substrate with a laser machining system. The laser machining system applies a plurality of radiation pulses to a substrate and forms a plurality of trenches around the edge of each optical device within the substrate. Each of the trenches are formed with varying depths and radial positions relative to one another, such that they enable the formation of a slanted outer surface of each optical device. Different draft angles may be desirable for different optical devices to improve certain optical qualities of the optical device.

By utilizing radiation pulses to form trenches at different depths, the outer surface of each optical device may be slanted to a desired draft angle by varying the number, length, or power of the radiation pulses applied to form each trench. With decreased radiation beam widths and an increased number of radiation beams, low roughness outer surfaces may be obtained along the slanted outer surfaces.

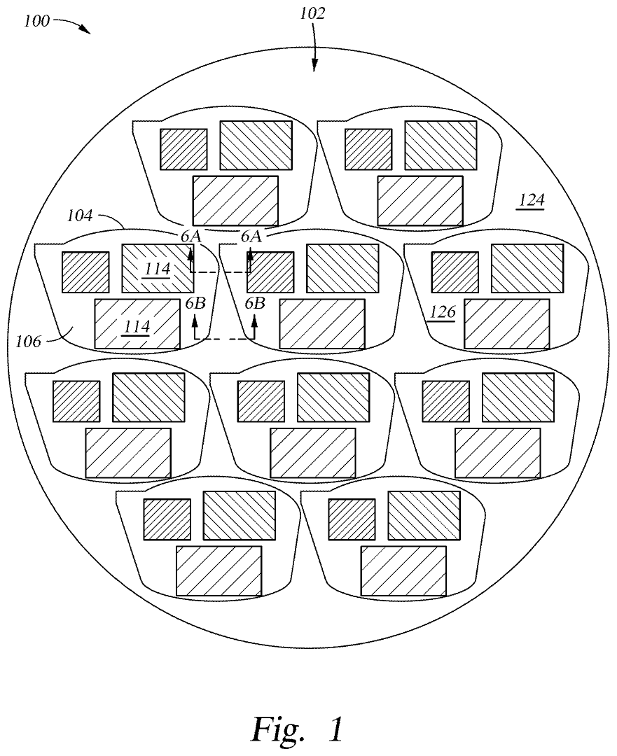

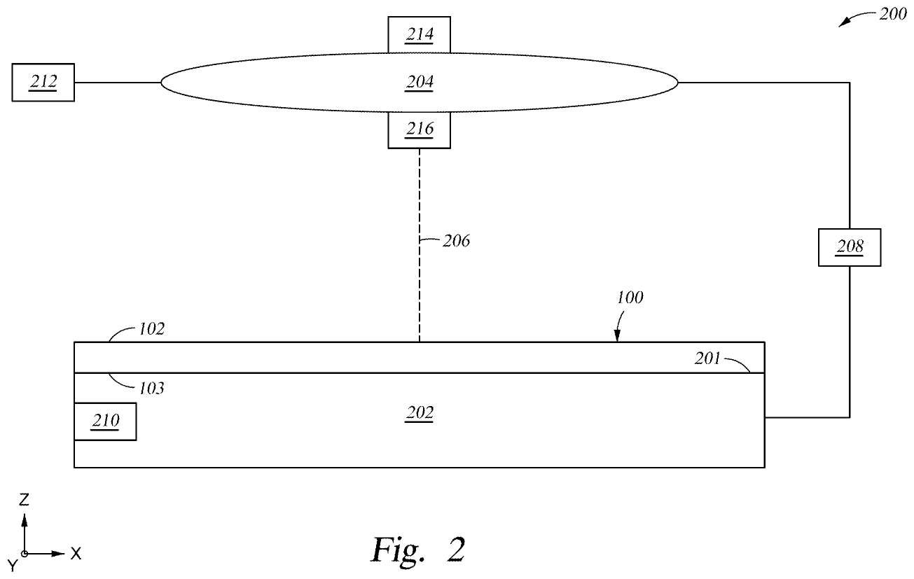

FIG. 1 is a schematic, top-view of a substrate 100. The substrate 100 includes a top surface 102 and a bottom surface 103 (FIG. 2) opposite the top surface 102. The substrate 100 includes one or more optical devices 106, disposed on the top surface 102 and/or the bottom surface 103 of the substrate. The one or more optical devices 106 can include structures 114 (i.e., fins) having sub-micron critical dimensions, e.g., nano-sized critical dimensions.

The substrate 100 may be formed from any suitable material, provided that the substrate 100 can adequately transmit or absorb light in a desired wavelength or wavelength range and can serve as an adequate support for the one or more optical devices 106. Substrate selection may include any suitable material, including, but not limited to, amorphous dielectrics, crystalline dielectrics, aluminum nitride, silicon oxide, silicon carbide, polyhedral oligomeric silsesquioxane (POSS), or combinations thereof. In some embodiments, which can be combined with other embodiments described herein, the substrate 100 include a transparent material. Suitable examples may include an oxide, sulfide, phosphide, telluride, or combinations thereof. In some embodiments, the substrate is formed from one or a combination of silicon, silicon carbide, silicon oxide, or aluminum nitride. Additionally, the substrate 100 may be varying shapes, thicknesses, and diameters. For example, the substrate 100 may have a diameter of about 150 mm to about 300 mm. The substrate 100 may have a circular, rectangular, or square shape. The substrate 100 may have a thickness of between about 300 μm to about 1 mm. The bandgap of the material of the substrate is about 5 eV to about 12 eV, such as about 6 eV to about 10 eV, such as about 8 eV to about 10 eV, such as about 9.2 eV.

It is to be understood that the one or more optical devices 106 described herein are exemplary optical devices. In one embodiment, which can be combined with other embodiments described herein, an optical device of the one or more optical devices 106 is a waveguide combiner, such as an augmented reality waveguide combiner. In another embodiment, which can be combined with other embodiments described herein, an optical device of the one or more optical devices 106 is a flat optical device, such as a metasurface.

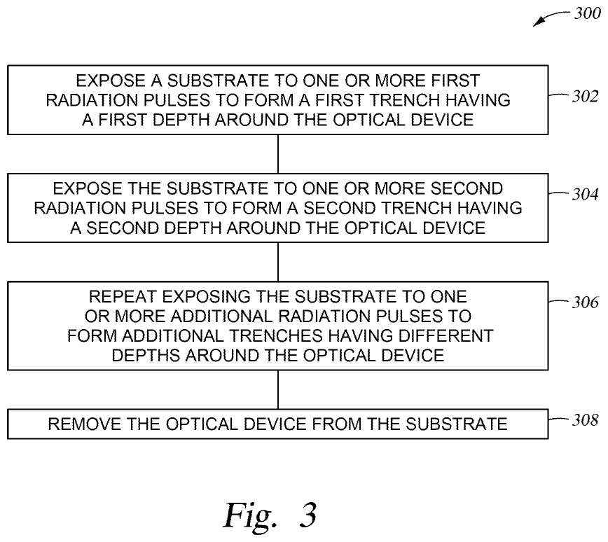

Each optical device 106 of the one or more optical devices 106 includes a dicing path 104. The dicing path 104 is disposed around the exterior edge of each optical device 106. The dicing path 104 is the desired dicing path for a laser (shown in FIG. 2) to travel along during the method 300 (FIG. 3) such that the quality of the optical device 106 is maintained. Although only ten optical devices 106 are shown on the substrate 100, any number of optical devices 106 may be disposed on the substrate 100. The portion of the substrate 100 which corresponds to each of the optical devices 106 is an optical device portion 126. The portion of the substrate 100 which is outside of the optical device portions 126 is an outer portion 124. During the method described herein, the optical device portions 126 forming each of the optical devices 106 are separated from the outer portion 124 of the substrate 100 along the dicing paths 104. The optical devices 106 may be separated via mechanical or thermal separation.

FIG. 2 is a schematic, cross-sectional view of a laser machining system 200. The laser machining system is utilized in a method 300 for dicing one or more optical devices from a substrate 100 with the laser machining system 200.

The laser machining system 200 includes a substrate 100 disposed on a surface 201 of a stage 202. The stage 202 is disposed in the laser machining system 200 such that the surface 201 of the stage 202 is positioned opposite a scanner 204. The scanner 204 includes a laser source 214, an optical array 216, and a laser 206 disposed from the optical array 216. The laser machining system 200 is operable to dice the one or more optical devices 106 from the substrate 100 along the dicing path 104. The laser machining system 200 includes a controller 208. The controller 208 is in communication with the stage 202 and the scanner 204.

The laser machining system 200 is operable to dice one or more optical devices 106 from a substrate 100. In one embodiment, which can be combined with other embodiments described herein, the laser machining system 200 is operable to utilize laser ablation to dice the one or more optical devices 106 from the substrate 100. Laser ablation includes supplying a radiation pulse from the laser source 214. The radiation pulse passes through the optical array 216 and is focused into the laser 206. The laser 206 etches a hole or a void in the substrate 100 through the thickness of the substrate 100 along the dicing path 104. The laser 206 may further etch a trench into the substrate 100 along the dicing path 104 with the laser 206.

The controller 208 is generally designed to facilitate the control and automation of the method described herein. The controller 208 may be coupled to or in communication with the laser source 214, the optical array 216, the stage 202, and the scanner 204. The stage 202 and the scanner 204 may provide information to the controller 208 regarding the method 300 and alignment of the substrate 100. The controller 208 may be in communication with or coupled to a CPU (i.e., a computer system). The CPU can be a hardware unit or combination of hardware units capable of executing software applications and processing data. In some configurations, the CPU includes a central processing unit (CPU), a digital signal processor (DSP), an application-specific integrated circuit (ASIC), a graphic processing unit (GPU) and/or a combination of such units. The CPU is generally configured to execute the one or more software applications and process stored media data. The controller 208 may include a non-transitory computer-readable medium for storing instructions of forming a dicing path along a substrate as described herein. The non-transitory computer-readable medium may be a part of the CPU.

The laser 206 is a pulsed laser. In one embodiment, which can be combined with other embodiments described herein, the laser 206 includes a Gaussian beam profile with a beam quality “M²-factor” of less than about 1.3. In another embodiment, which can be combined with other embodiments described herein, the laser 206 is a Bessel-type beam profile. In yet other embodiments, the laser 206 is a multi-focus laser and uses a bifocal lens as part of the optical array 216. Multiple lenses may also be used within the optical array 216 to diffract the laser 206 and form multiple focal points within the substrate 100. The laser 206 is in communication with the controller 208. The controller 208 may control other input parameters or output parameters of the laser 206, as described in the method 300.

The stage 202 includes a stage actuator 210. The stage actuator 210 allows the stage 202 to scan in the X direction, the Y direction, and the Z direction, as indicated by the coordinate system shown in FIG. 2. The stage 202 is coupled to the controller 208 in order to provide information of the location of the stage 202 to the controller 208. Additionally, the stage 202 is in communication with the controller 208 such that the stage 202 may move in a direction such that the laser 206 traces the dicing path 104.

The scanner 204 includes a scanner actuator 212. The scanner actuator 212 allows the scanner 204 to scan in the X direction, the Y direction, and the Z direction, as indicated by the coordinate system shown in FIG. 2. The laser source 214 and the optical array 216 are disposed in the scanner 204. The scanner 204 is coupled to the controller 208 in order to provide information of the location of the scanner 204 to the controller 208. Additionally, the scanner 204 is in communication with the controller 208 such that the scanner 204 may move the laser 206 to trace the dicing path 104. In one embodiment, which can be combined with other embodiments described herein, the scanner 204 is a galvo scanner.

In one embodiment, which can be combined with other embodiments described herein, the laser machining system 200 performing a method for dicing one or more optical devices 106 from a substrate 100 may utilize both the scanner 204 and the stage 202 to direct the laser 206 along the dicing path 104. In another embodiment, which can be combined with other embodiments described herein, the laser machining system 200 performing the method for dicing one or more optical devices 106 from a substrate 100 may utilize only the scanner 204 to direct the laser 206 along the dicing path 104. In yet another embodiment, which can be combined with other embodiments described herein, the laser machining system 200 performing the method for dicing one or more optical devices 106 from a substrate 100 may utilize only the stage 202 to direct the laser 206 along the dicing path 104.

In embodiments with a substrate 100 including glass, the scanner 204 and the laser 206 are in a fixed position. The stage 202 is scanned such that the laser 206 moves along the dicing path 104. The laser 206 includes a Gaussian type beam profile. The laser 206 is an ultra-violet (UV) laser. The wavelength of the laser 206 is less than about 500 nm. The laser 206 has a beam width of less than about 33 μm, such as less than about 25 μm, such as less than about 15 μm at the substrate 100.

In embodiments with a substrate 100 including silicon carbide, the scanner 204, such as a galvo scanner, is utilized to scan the laser 206 along the dicing path 104. The stage 202 is utilized to scan the substrate 100 between the plurality of sections such that the laser 206 may move along each section along the dicing path 104. The laser 206 includes a Gaussian type beam profile. The laser 206 is absorptive in the substrate 100 including silicon carbide, and thus is able to dice the one or more optical devices 106 of the substrate 100. The laser 206 may be an infrared laser with a wavelength of about 1.0 μm to about 5 μm and the photon energy of the laser 206 may be less than about 1.0 eV.

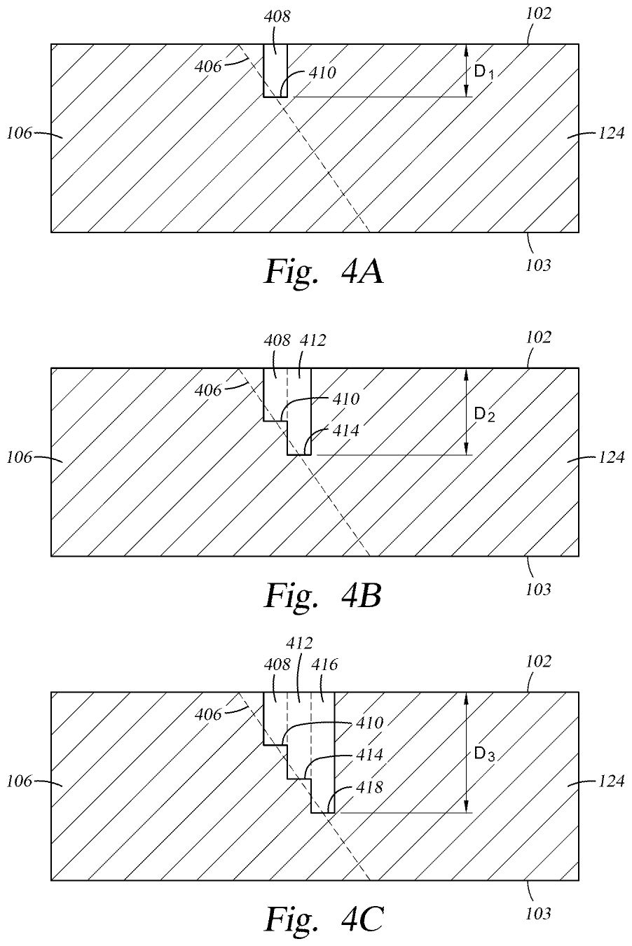

FIG. 3 is a flow diagram of a method 300 for dicing one or more optical devices 106 from a substrate 100. The method 300 enables the optical devices 106 to be diced from the substrate 100 with slanted sidewalls, such that the sidewalls are disposed at an angle other than 90 degrees with respect to the top surface 102 and the bottom surface 103 of the substrate 100. Having angled sidewalls of the optical devices 106 enables improved device performance in some applications. The angle of the sidewalls relative to a vertical plane normal to the top surface 102 and the bottom surface 103 may be referred to as the draft angle. The method 300 has been shown to enable smoother sidewalls and an adjustable draft angle, while the number of chipping defects and the die strength remain the same. The method 300 is further illustrated in FIGS. 4A-4E. FIGS. 4A-4E illustrate schematic cross-sectional views of an optical device 106 and the substrate 100 during different operations of the dicing method 300.

The method 300 includes an operation 302 of exposing a substrate, such as the substrate 100, to one or more first radiation pulses. Exposing the substrate to one or more first radiation pulses forms a first trench 408 as shown in FIG. 4A. The first trench 408 is formed along the dicing path 104. The dicing path 104 is a path surrounding the circumference of one of the optical devices 106. The dicing path 104 may form a silhouette around one of the optical devices 106. The dicing path 104 changes as the dicing path 104 extends into the substrate 100 from the top surface 102 to the bottom surface 103. In embodiments described herein, the dicing path 104 extends at an angle Φ through the substrate 100 along a taper line 406. The taper line 406 is a reference line indicating an approximation of an expected or chosen edge shape. The taper line 406 may be a linear, curved, or piecewise shape, such that the shape of the edge of each optical device 106 may be varied.

In the embodiment of FIGS. 4A-4E, the taper line 406 and the subsequent edge shape from the top surface 102 to the bottom surface 103 is linear. The cross-sectional area of the optical device 106 therefore increases as the optical device 106 extends towards the bottom surface 103. The angle Φ is the angle with respect to a plane normal to the top surface 102 and/or the bottom surface 103. The angle Φ may be referred to as a taper angle and is about 1 degree to about 45 degrees, such as about 2 degrees to about 30 degrees, such as about 3 degrees to about 15 degrees, such as about 5 degrees to about 10 degrees.

The first trench 408 has a bottom surface 410, which intersects the taper line 406. The bottom surface 410 may intersect the taper line 406 at either an inner extreme, an outer extreme, or a midpoint of the bottom surface 410. The bottom surface 410 of the first trench 408 is offset from the top surface 102 of the substrate 100 by a first depth D₁. The first depth D₁ of the first trench 408 at least partially defines the angle of the taper line 406. The first trench 408 as described herein may be either a continuous trench around the entire circumference of the optical device 106 or several trenches around portions of the circumference of the optical device.

The first trench 408 may be formed during the operation 302 using one or more bursts of first radiation pulses. Each of the one or more bursts includes a plurality of first radiation pulses. The first radiation pulses are delivered from the laser source 214 to the top surface 102 of the substrate 100. The first radiation pulses are UV radiation pulses. The first radiation pulses have a wavelength of less than about 500 nm, such as less than about 400 nm, such as about 100 nm to about 400 nm, such as about 200 nm to about 400 nm, such as about 250 nm to about 375 nm. The wavelength of the first radiation pulses may be varied depending on the 3^{rd} harmonic generation crystal materials utilized. The frequency of the first radiation pulses is greater than 50 kHz, such as greater than 100 kHz, such as greater than 500 kHz, such as greater than 1 MHz, such as greater than 100 MHz, such as greater than 250 MHz, such as greater than 500 MHz, such as greater than 1 GHz. In some embodiments, the frequency of the first radiation pulses is described as a pulse repetition rate and the first radiation pulses are provided to the substrate 100 at the pulse repetition rate described herein. Using a high pulse frequency, such as 1 GHz or greater, enables the total burst energy applied to the substrate 100 to be maintained, while the individual pulse energy is increased and the pulse width is decreased.

The pulse width of each of the first radiation pulses is less than about 15 picoseconds, such as less than about 12 picoseconds, such as less than 10 picoseconds, such as less than about 5 picoseconds, such as less than about 2 picoseconds, such as about 500 femtoseconds. The pulse energy of each of the first radiation pulses is greater than about 30 nanojoules, such as greater than about 80 nanojoules, such as greater than about 100 nanojoules, such as greater than about 200 nanojoules. The pulse energy of each of the first radiation pulses is less than about 50 microjoules, such as less than about 40 microjoules, such as less than about 30 microjoules. There are a plurality of first radiation pulses within a first burst of radiation pulses. The first burst of radiation pulses includes 5 to 300 first radiation pulses, such as 10 to 250 first radiation pulses, such as 20 to 150 first radiation pulses. The total burst energy is about 400 nanojoules to about 30 microjoules, such as about 1 microjoule to about 30 microjoules, such as about 1 microjoule to about 20 microjoules.

After forming the first trench 408, at operation 304, the substrate is exposed to one or more second radiation pulses to form a second trench 412 as shown in FIG. 4B. The one or more second radiation pulses are similar to the one or more first radiation pulses in frequency, wavelength, pulse width, and pulse energy. The total burst energy may be changed, such that the number of pulses or the pulse width may be increased. Increasing the total burst energy enables the second trench 412 to be formed to a second depth D₂. In some embodiments, the depth of focus/focal spot size of the radiation pulses is changed to enable forming the second depth D₂ of the second trench 412. The second depth D₂ is greater than the first depth D₁. The second depth D₂ is defined between the top surface 102 of the substrate 100 and the bottom surface 414 of the second trench 412. The difference between the first depth D₁ and the second depth D₂ may be varied depending on the slope of the taper line 406 and the width of each of the first trench 408 and the second trench 412. In one embodiment, the difference between the first depth D₁ and the second depth D₂ is about 1 micrometer (μm) to about 10 μm, such as about 1 μm to about 5 μm, such as about 2 μm to about 4 μm, such as about 2 μm to about 3 μm, such as about 2 μm or about 2.5 μm. When the difference between the first depth D₁ and the second depth D2 is reduced, the roughness of the sidewall of the optical device 106 is reduced.

The bottom surface 414 of the second trench 412 intersects the taper line 406. The bottom surface 414 intersects the taper line 406 at either an inner extreme, an outer extreme, or a midpoint of the bottom surface 414. In embodiments where the bottom surface 414 intersects the taper line 406 at an inner extreme, the bottom surface 410 also intersects the taper line 406 at the inner extreme. When the bottom surface 414 of the second trench 412 intersects the taper line 406 at an outer extreme, the bottom surface 410 of the first trench 408 also intersects the taper line 406 at the outer extreme. When the bottom surface 414 of the second trench 412 intersects the taper line 406 at a midpoint, the bottom surface 410 of the first trench 408 also intersects the taper line 406 at the midpoint.

After forming the second trench 412, the substrate is exposed to one or more additional radiation pulses to form additional trenches having different depths during an operation 306. Exemplary additional trenches at different depths are illustrates in FIGS. 4C-4E. The one or more additional radiation pulses include at least one or more third radiation pulses to form a third trench 416 as shown in FIG. 4C, one or more fourth radiation pulses to form a fourth trench 420 as shown in FIG. 4D, and one or more fifth radiation pulses to form a fifth trench 424 as shown in FIG. 4E. The one or more additional trenches are therefore formed by exposing the substrate to one or more additional radiation pulses around the circumference of the optical device. Each additional trench of the one or more additional trenches has a depth greater than a previous depth of a previously formed trench. Each subsequently formed additional trench is concentric about the previously formed additional trench. In some embodiments, each additional trench of the one or more additional trenches is greater in depth than the trench immediately preceding the additional trench.

A plurality of additional trenches may be formed depending on the desired sidewall roughness, the desired slope, and the total thickness of the substrate 100. In some embodiments, there are about 100 trenches to about 750 trenches formed, such as about 100 trenches to about 500 trenches formed, such as about 150 trenches to about 300 trenches formed. The one or more additional radiation pulses are similar to the one or more first radiation pulses or the one or more second radiation pulses in frequency, wavelength, pulse width, and pulse energy. The total burst energy may be changed, such that the number of pulses or the pulse width may be increased. Increasing the total burst energy enables the additional trenches to be formed at varying depths.

The third trench 416 is formed to a third depth D₃, the fourth trench 420 is formed to a fourth depth D₄, and the fifth trench 424 is formed to a fifth depth D₅. The third depth D₃ is greater than the second depth D₂. The fourth depth D₄ is greater than the third depth D₃. The fifth depth D₅ is greater than the fourth depth D₄. The third depth D₃ is defined between the top surface 102 of the substrate 100 and a bottom surface 418 of the third trench 416. The fourth depth D₄ is defined between the top surface 102 of the substrate 100 and a bottom surface 422 of the fourth trench 420. The fifth depth D₅ is defined between the top surface 102 of the substrate 100 and a bottom surface 426 of the fifth trench 424. Each of the bottom surfaces 410, 414, 418, 422, 426 intersect the taper line 406. The bottom surfaces 410, 414, 418, 422, 426 intersect the taper line 406 at a similar inner extreme, outer extreme, or midpoint of the bottom surface of each bottom surface 410, 414, 418, 422, 426. The bottom surface 426 of the fifth trench 424 is illustrated as being formed through the bottom surface 103 of the substrate 100. In this embodiment, the fifth depth D₅ is the same as the total thickness of the substrate 100. In alternative embodiments, the fifth depth D₅ is only a fraction of the total thickness of the substrate 100 and additional trenches are formed. In some embodiments, none of the trenches pass completely through the substrate and instead are only formed through a fraction of the substrate thickness. The optical devices 106 are then subsequently removed using other methods.

The difference between the depths of each of the trenches 416, 420, 424 may be varied depending on the slope of the taper line 406 and the width of each of the trenches 416, 420, 424. In one embodiment, the difference in depth between each adjacent trench is about 1 micrometer (μm) to about 7.5 μm, such as about 1 μm to about 5 μm, such as about 2 μm to about 4 μm, such as about 2 μm to about 3 μm, such as about 2 μm or about 2.5 μm.

Each of the trenches are formed radially outward of the previously formed optical trenches and form a slanted sidewall. Each trench alternatively is formed radially inward of the previously formed optical trenches to form the slanted sidewall. Each of the trenches are formed concentrically about the previously formed trenches and the optical device 106.

The plurality of trenches may subsequently be formed around each of the optical devices 106 within the substrate 100. In some embodiments, the trenches are formed around each of the optical devices 106 simultaneously using a plurality of lasers.

After forming the plurality of trenches, the optical device 106 is removed from the substrate 100 during an operation 308. The optical device 106 may be removed from the substrate 100 using thermal treatment, chemical treatment, or mechanical separation techniques. The optical device 106 may be removed from the substrate 100 in a process chamber or stage different from the laser machining system 200.

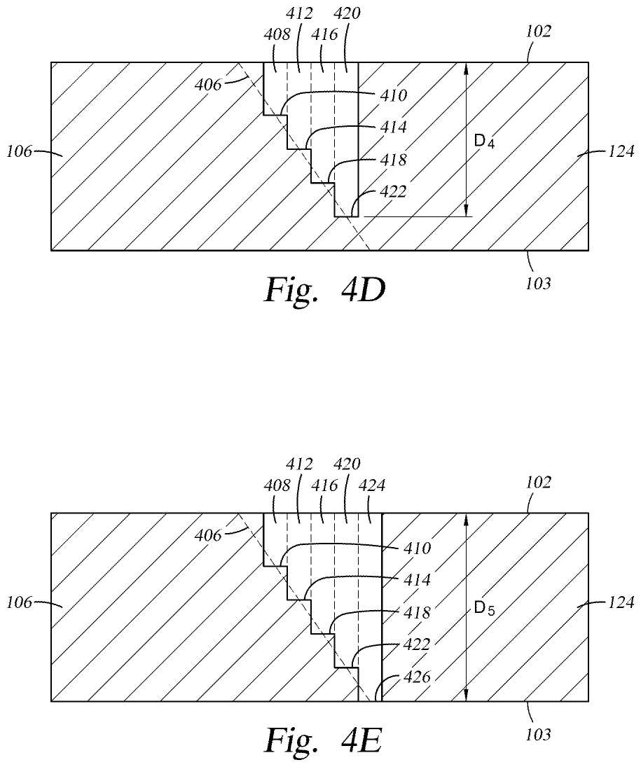

FIG. 5 is a schematic plan view of an optical device 106 from a substrate 100. The dicing path 104 of the laser machining system 200 is provided around the circumference of the optical device 106. The dicing path 104 includes multiple silhouettes 504, 506, 508 of the optical device 106. Each of the silhouettes 504, 506, 508 is disposed around the circumference of the optical device 106. Each of the silhouettes 504, 506, 508 are concentric with one another and the one or more trenches are formed along the silhouettes 504, 506, 508. In one embodiment, the first trench 408 is formed along a first silhouette 504. The second trench 412 is formed along the second silhouette 506. The third trench 416 is formed along a third silhouette 508. Additional trenches may also be formed along additional silhouettes, such as the fourth trench 420 and the fifth trench 424 of FIGS. 4D and 4E being formed along a fourth silhouette or a fifth silhouette (not shown).

Each of the trenches 408, 412, 416, 420, 424 and the corresponding silhouettes 504, 506, 508 are formed using a plurality of radiation pulses. Each of the radiation pulses are applied to the substrate at one or more pulse positions 502a, 502b, 502c, 502n. As shown herein, one or more first radiation pulses is applied to the first pulse position 502a before one of the substrate 100 or the scanner 204 are moved to apply one or more second radiation pulses to the second pulse position 502b. The substrate 100 and/or the scanner 204 may subsequently be moved to apply one or more third radiation pulses to the third pulse position 502c. Additional radiation pulses are applied around the circumference of the first silhouette 504 to form the first trench 408. A last pulse position 502n is disposed adjacent to the first pulse position 502a. Each of the adjacent pulse positions 502a, 502b, 502c, 502n overlap in some embodiments to form a continuous trench. In some embodiments, the silhouette 504 may be formed using a single burst of radiation pulses or a plurality of bursts of radiation pulses. Each of the voids at each of the first pulse position 502a, the second pulse position 502b, the third pulse position 502c, and the last pulse position 502n are formed using a burst of radiation pulses.

The silhouettes as described herein, may be the path around which the radiation pulses are applied, such that the center of each of the pulse positions 502a, 502b, 502c, 502n are disposed on the first silhouette 504. Although not shown for clarity, similar pulse positions are disposed on each of the second silhouette 506 and the third silhouette 508. Each of the silhouettes 504, 506, 508 are disposed at different radial positions relative to the exterior edge of the optical device 106. The exterior edge of the optical device 106 as described herein is the inner edge of the dicing path 104. The first silhouette 504 is disposed a first radial distance R₁ from the exterior edge of the optical device 106. The second silhouette 506 is disposed a second radial distance R₂ from the exterior edge of the optical device 106. The third silhouette 508 is disposed a third radial distance R₃ from the exterior edge of the optical device 106. The second radial distance R₂ is greater than the first radial distance R₁. The third radial distance R₃ is greater than the second radial distance R₂. The first radial distance R₁ and the second radial distance R₂ are separated by a radial difference. The second radial distance R₂ and the third radial distance R₃ are separated by a similar radial difference to the radial difference between the first radial distance R₁ and the second radial distance R₂. The radial difference between each of the silhouettes is less than about 10 μm, such as less than about 5 μm, such as less than about 3 μm.

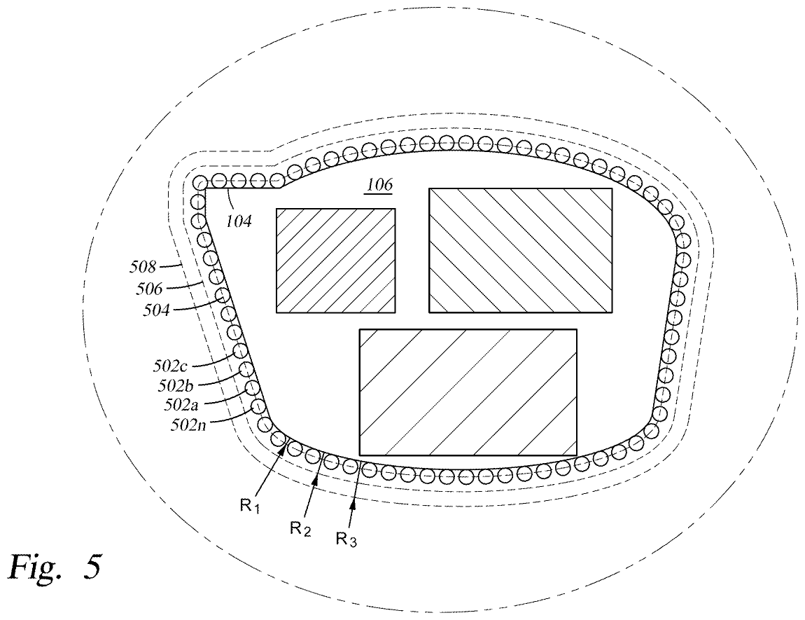

FIGS. 6A-6B are schematic cross-sectional views of an optical device 106 after dicing. The optical device 106 is diced using the method 300 of FIG. 3. Each of the trenches 408, 412, 416, 420, 424 form a portion of the device edge 602. In FIG. 6A, two adjacent optical devices 106, 106′ are shown at a first dicing position. The first dicing position is the position between two adjacent optical devices 106, 106′ where the diced trenches of both of a first optical device 106 and a second optical device 106′ are close enough to form a single perforation 604 between the first optical device 106 and the second optical device 106′. Using a single perforation 604 reduces the amount of wasted material and the likelihood of cracking or chipping along the edge of each of the optical devices 106, 106′. The second optical device 106′ is diced using a similar method to the first optical device 106 and includes a top surface 102′, a bottom surface 103′ and a device edge 602′ formed along a dicing path 104′.

The device edges 602, 602′ are shown as linear surfaces, but may be curved or stepped surfaces. The number of trenches formed to dice each of the optical devices 106, 106′ are increased to reduce the roughness of the device edges 602, 602′. When a large enough number of trenches are utilized, such as greater than 50 trenches or greater than 100 trenches, the device edges 602, 602′ may approximate a smooth surface.

The device edges 602, 602′ are disposed at the angle ϕ. The angle ϕ is an angle from a plane disposed between a reference plane and the device edge 602, 602′. The reference plane is normal to both the top surfaces 102, 102′ and the bottom surfaces 103, 103′ of the substrate 100.

When a larger distance separates the first optical device 106 and the second optical device 106′, the outer portion 124 is disposed between each of the device edges 602, 602′. In this embodiment, there are multiple perforations. A first perforation 606 separates the first optical device 106 and the outer portion 124. A second perforation 606′ separates the second optical device 106′ and the outer portion 124. The trenches formed to dice each of the optical devices 106, 106′ have an outer surface 608, 608′. The outer surfaces 608, 608′ are vertical surfaces and opposite the device edges 602, 602′.

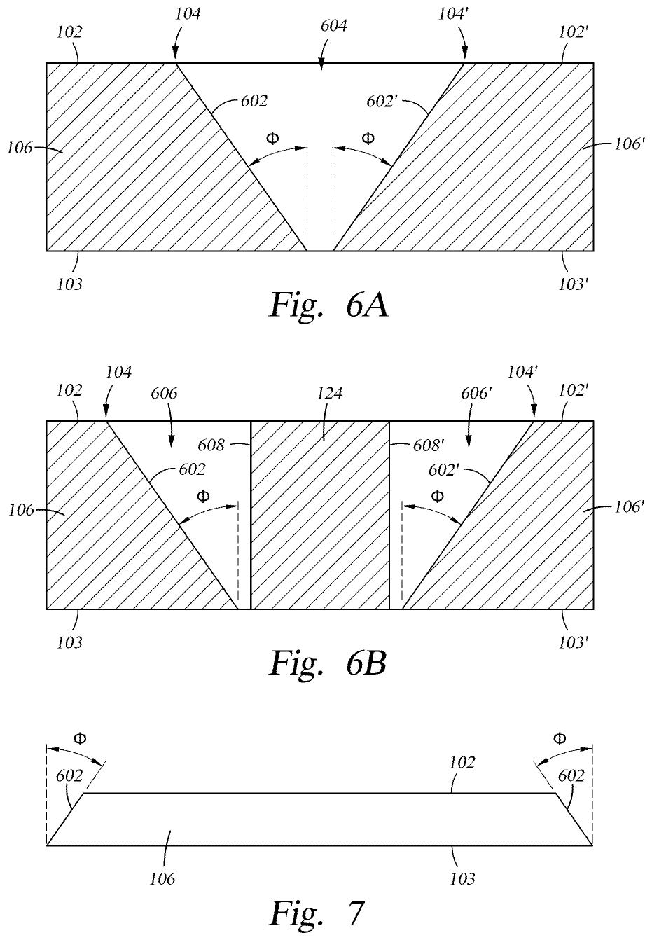

FIG. 7 is a schematic side view of an optical device 106 after dicing. The optical device 106 includes the slanted device edge 602 between the top surface 102 and the bottom surface 103. The slanted device edge 602 is disposed at the angle ϕ. The angle ϕ may be constant around the device edge 602 or may change at different points around the circumference of the optical device 106.

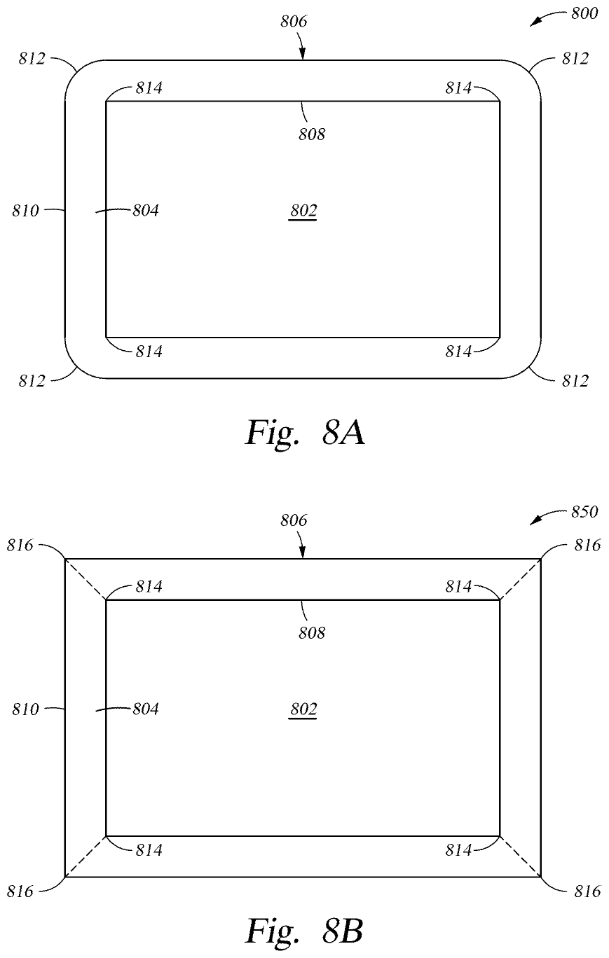

FIGS. 8A-8B are schematic plan views of optical device 800, 850 after dicing. The optical devices 800, 850 illustrate how the shape of each device edge 804 may be changed using the method described herein. Both of the optical devices 800, 850 include an upper surface 802, a lower surface 806, and a slanted device edge 804. The shapes of the outer edges of each of the upper surface 802 and the lower surface 806 are changed between the first optical device 800 and the second optical device 850.

In the first optical device 800, the upper surface 802 has a rectangular outer circumference 808, such that the outer circumference 808 has a shape with corners 814 disposed at 90 degree angles. The lower surface 806 has a rectangular outer circumference 810, but the corners 812 are curved, such that each of the corners 812 have a fillet.

In the second optical device 850, the upper surface 802 again has a rectangular outer circumference 808 with sharp corners 814. Unlike the first optical device 800, the lower surface 806 of the second optical device 850 also has a rectangular outer circumference 810 with corners 816 disposed at 90 degree angles. The different shapes of the upper surface 802 and the lower surface 806 are enabled by using different combinations of trench spacing and trench depth. The trenches may similarly follow different silhouettes as the trenches progress radially outward or inward from the edge of the upper surface 802 of the optical devices 800, 850.

The apparatus and method described herein enable the dicing of optical devices from a substrate in a manner which produces slanted edges of each optical device. The angle/shape of the slanted edges may be varied by forming concentric trenches with varying depths. The trenches are formed using laser ablation. During laser ablation, a plurality of radiation pulses are applied to the substrate around the dicing path of one or more optical devices. The method described herein further enables the shape of the optical device edges to change at different portions of the circumference of the optical device. Enabling various edge shapes/angles assists in obtaining improved optical performance of the optical devices during some applications.

While the foregoing is directed to embodiments of the present disclosure, other and further embodiments of the disclosure may be devised without departing from the basic scope thereof, and the scope thereof is determined by the claims that follow.

1. A method of dicing an optical device from a substrate comprising:
forming a first trench by exposing the substrate to one or more first radiation pulses around a circumference of the optical device, the first trench having a first depth;
forming a second trench by exposing the substrate to one or more second radiation pulses around the circumference of the optical device, the second trench having a second depth greater than the first depth and the second trench being concentric about the first trench; and
forming one or more additional trenches by exposing the substrate to one or more additional radiation pulses around the circumference of the optical device, each additional trench of the one or more additional trenches having a depth greater than a previous depth of a previously formed trench, each subsequently formed additional trench concentric about a previously formed additional trench.

2. The method of claim 1, wherein each of the one or more first radiation pulses has a pulse width of less than about 30 picoseconds.

3. The method of claim 1, wherein the one or more second radiation pulses are delivered outward of the one or more first radiation pulses by a radial distance of about 0.01 mm to about 0.05 mm.

4. The method of claim 1, wherein the first trench and the second trench a tapered edge of the optical device, the tapered edge having a taper angle of about 1 degree to about 45 degrees with respect to a plane normal to a top substrate surface.

5. The method of claim 1, wherein the substrate comprises one or a combination of silicon, silicon carbide, silicon oxide, or aluminum nitride.

6. The method of claim 1, wherein the one or more first radiation pulses and the one or more second radiation pulses have a wavelength of less than about 500 nm.

7. The method of claim 1, wherein each of the one or more first radiation pulses and the one or more second radiation pulses are delivered to one or more concentric silhouettes around the optical device.

8. The method of claim 1, wherein each of the first radiation pulses and each of the second radiation pulses have a pulse energy of less than about 50 μJ.

9. A method of dicing one or more optical devices within a substrate comprising:
forming a first tapered edge around a first optical device by forming a plurality of trenches around the first optical device using one or more bursts of radiation pulses, the plurality of trenches varying in depth from a top surface of the substrate;
forming a second tapered edge around a second optical device by forming a plurality of trenches around the second optical device using one or more bursts of radiation pulses, the plurality of trenches varying in depth from the top surface of the substrate; and
removing the first optical device and the second optical device from the substrate after forming the first tapered edge and the second tapered edge.

10. The method of claim 9, wherein the first tapered edge and the second tapered edge are disposed at an angle of about 1 degree and about 45 degrees, the angle defined between a plane normal to the top surface of the substrate and a taper line of each of the first optical device and the second optical device, wherein the taper line of each of the first optical device and the second optical device intersects a discreet point on each of the plurality of trenches.

11. The method of claim 10, wherein the one or more bursts of radiation pulses comprise:
a pulse width of less than about 15 picoseconds;
a pulse frequency of greater than 50 kHz; and
a pulse energy of less than 200 nJ.

12. A non-transitory computer-readable medium storing instructions that, when executed by a processor, cause a computer system to perform the steps of:
forming a tapered edge around a first optical device by:
instructing a laser source to deliver one or more first radiation pulses to a substrate around a circumference of the first optical device to form a first trench, the first trench having a first depth and the substrate disposed on a stage, one or both of the stage and the laser source being instructed to move during delivery of the first radiation pulses;
instructing the laser source to deliver one or more second radiation pulses to the substrate around the circumference of the first optical device to form a second trench, the second trench having a second depth greater than the first depth and the second trench radially outward of the first trench, and one or both of the stage and the laser source being instructed to move during delivery of the first radiation pulses; and
instructing the laser source to deliver one or more additional radiation pulses to the substrate around the circumference of the first optical device to form one or more additional trenches, each additional trench of the one or more additional trenches having a depth greater than a previous depth of a previously formed trench, each subsequently formed additional trench concentric about a previously formed additional trench, and one or both of the stage and the laser source being instructed to move during delivery of the one or more additional radiation pulses.

13. The non-transitory computer-readable medium of claim 12, wherein the tapered edge is disposed at an angle other than 0 degrees with respect to a vertical plane normal to a top substrate surface.

14. The non-transitory computer-readable medium of claim 13, wherein the angle of the tapered edge is about 1 degree to about 45 degrees.

15. The non-transitory computer-readable medium of claim 12, wherein each of the first radiation pulses and each of the second radiation pulses have a pulse width of less than about 15 picoseconds.

16. The non-transitory computer-readable medium of claim 15, wherein each of the first radiation pulses and each of the second radiation pulses have a pulse frequency of greater than 50 kHz.

17. The non-transitory computer-readable medium of claim 16, wherein each of the first radiation pulses and each of the second radiation pulses have a pulse energy of less than 200 nJ.

18. The non-transitory computer-readable medium of claim 17, wherein each the first radiation pulses are delivered in a first burst and the second radiation pulses are delivered in a second burst, each of the first burst and the second burst having a burst energy of less than about 40 μJ.

19. The non-transitory computer-readable medium of claim 12, wherein the first trench is formed along a first silhouette and the second trench is formed along a second silhouette, the first silhouette separated from the second silhouette by a radial distance of about 0.01 mm to about 0.05 mm.

20. The non-transitory computer-readable medium of claim 12, wherein a change in depth between the first trench and the second trench is about 1 μm to about 7.5 μm.
